(19) United States
(12) Patent Application Publication
(10) Pub. No.: US 2006/0112141 A1
(43) Pub. Date: May 25, 2006

(54) System for automatically creating a metadata repository for multimedia

(76) Inventor: Robert P. Morris, Raleigh, NC (US)

Correspondence Address: IPAC, 111 Corning Road, Suite 220, Cary, NC, 27511, US

(21) Appl. No.: 10/996,668

(22) Filed: Nov. 24, 2004

(51) Int. Cl. G06F 17/30

(52) U.S. Cl. 707/104.1; 707/102

(57) ABSTRACT

A method and system for automatically creating a metadata repository for multimedia objects includes a service URL in the metadata associated with a multimedia object. The service URL is used by an application to access a service profile application to retrieve a service profile. The service profile describes the services available to the multimedia object and how to invoke these services. One of the services that can be provided is a metadata service that allows users to view, modify, or search the metadata for the multimedia object. In this manner, a common mechanism for providing information related to the multimedia object and for providing or advertising services related to the object is provided.

### CROSS-REFERENCE TO RELATED APPLICATIONS

This application is related to co-pending U.S. patent application Ser. No. ______, entitled “Interactive System for Collecting Metadata” (1268/3350P), filed on ______.

### FIELD OF THE INVENTION

The present invention relates to metadata for multimedia objects, and more particularly to creating a metadata repository for multimedia objects.

### BACKGROUND OF THE INVENTION

Currently, images or other multimedia objects are provided on web sites with embedded metadata which a web browser or other application could make available to the user. However, several problems exist with the current way in which the metadata is managed or used.

Typically the user does not have access to any additional data about the object other than its source URL and cannot add to this information at the source of the object. Thus, an opportunity is lost for knowledgeable users to enhance the information about the object.

Typically, the objects retrieved for display in web pages are copies of the original, reduced in size with most or all of the metadata removed to boost the performance of the image retrieval operation. Thus, the metadata is not able to be useful to the user.

Different copies of the same object may contain different metadata as the copies become out of sync. When metadata is provided or updated for an object, the existing copies of the object do not have access to the new metadata. In addition, there is no method to track the usage and relationships of one object with other objects.

Metadata is more likely to be collected in situations where it is important to the user. However, most existing mechanisms make metadata input a task separate from the use of the object. In such situations, it is not always clear what data should be collected other than a few obvious details, such as time of image capture and a short description. Thus, the metadata inadequately addresses the interests of the user.

Accordingly, there exists a need for a method and system for automatically creating a metadata repository for multimedia objects. The method and system should provide a common mechanism for managing metadata associated with images or other multimedia objects provided on a web site.

### SUMMARY OF THE INVENTION

A method and system for automatically creating a metadata repository for multimedia objects includes a service URL in the metadata associated with a multimedia object. The service URL is used by an application to access a service profile application to retrieve a service profile. The service profile describes the services available to the multimedia object and how to invoke these services. One of the services that can be provided is a metadata service that allows users to view, modify, or search the metadata for the multimedia object. In this manner, a common mechanism for providing information related to the multimedia object and for providing or advertising services related to the object is provided.

### BRIEF DESCRIPTION OF THE FIGURES

FIG. 1 illustrates a preferred embodiment of a system in accordance with the present invention.

FIG. 2 is a flowchart of a preferred embodiment of a method in accordance with the present invention.

FIG. 3 illustrates a first implementation of the system in accordance with the present invention.

FIG. 4 illustrates a second implementation of the system in accordance with the present invention.

FIG. 5 is a flowchart illustrating a preferred embodiment of a method for processing a service request in accordance with the present invention.

FIGS. 6A-6B illustrate an example service profile.

FIG. 7 illustrates the display of an example web page by a browser in making a metadata service available in accordance with the present invention.

FIG. 8 illustrates a preferred embodiment of a system for providing the metadata service in accordance with the present invention.

FIG. 9 is a flowchart illustrating a preferred embodiment of a method for providing the metadata service in accordance with the present invention.

### DETAILED DESCRIPTION

The present invention provides a method and system for automatically creating a metadata repository for multimedia objects. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

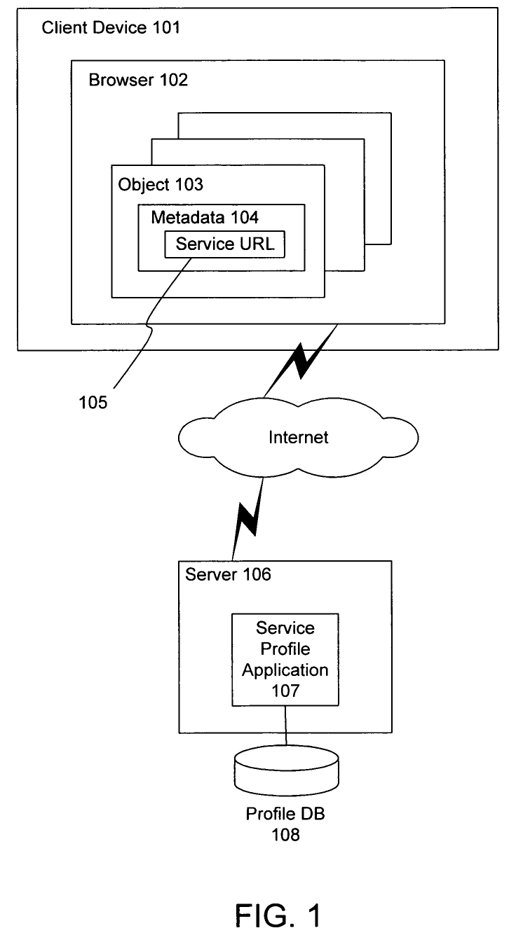

FIG. 1 illustrates a preferred embodiment of a system in accordance with the present invention. The system includes a client device 101 capable of supporting a browser 102. The browser 102 is capable of displaying multimedia objects 103, such as images, audio, and video. The objects 103 have metadata 104 associated with them. The metadata 104 includes a service uniform resource locator (URL) 105, which references a server 106 where the browser can retrieve services available for the object 103. The server 106 includes a service profile application 107, which manages service profiles for various objects stored in a profile database 108. Each service profile describes the services available to an object based on its identity, type, source, owner, or other attribute and how to invoke each service.

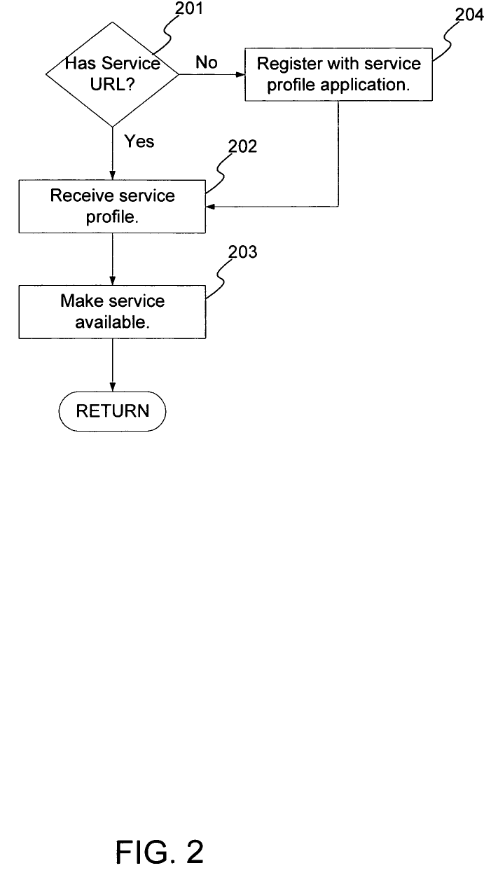

FIG. 2 is a flowchart of a preferred embodiment of a method in accordance with the present invention. First, it is determined if the metadata 104 of an object 103 includes a service URL 105, via step 201. If no service URL 105 is associated with the object 103, then the object 103 is registered with the service profile application 107, via step 204. Upon registration, the service URL 105 to be associated with the object 103 is determined. For example, the context data and rules from the service profile application 107 or the client environment can be used to determine which services to make available and how they are to be presented. The browser 102 receives this service URL 105 and requests the originating application to store the object 103 with this service URL 105 in the profile database 108. This service URL 105 can then be used to obtain the service profile, via step 202. Once the service profile for the object 103 is received from the service profile application, the service described in the service profile is made available, via step 203. For example, a list of available services can be displayed in the context menu when the user right-clicks on the object 103. The user can then select one of the services listed.

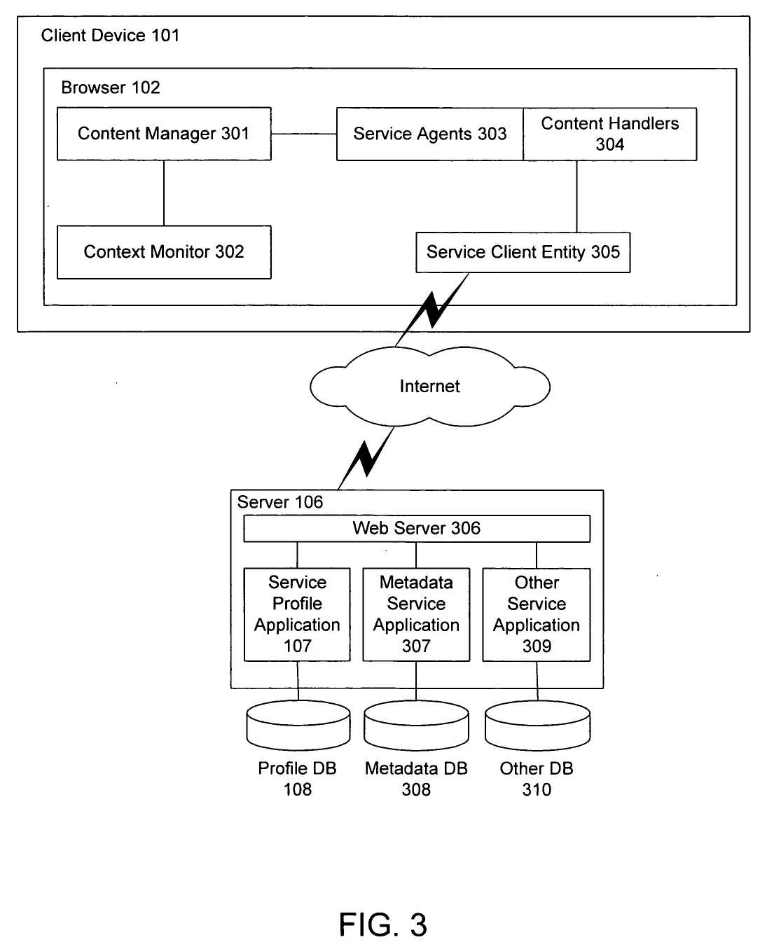

FIG. 3 illustrates a first implementation of the system in accordance with the present invention. In this implementation, the browser 102 includes a content manager 301, a content handler 304 for each data type, and a service agent 303 associated with each content handler 304. The browser 102 further includes a service client entity 305 for facilitating communication between the service agents 303 and the server 106. The content manager 301 determines the type of data associated with the object 103 and routes the data to the content handler 304 associated with the data type. The service agents 303 are plug-ins for various data types and are associated with a content handler 304 for their data type. They intercept the data and calls from the content manager 301 to their associated content handler 304. The service agents 303 then ensures that the object 103 has a service URL 105, communicates with the service profile application 107 through the service client entity 305 using the service URL 105, processes the service profile received from the service profile application 107, and makes the services described in the service profile available through the browser 102. For example, the services may be made available to the user through an object's context menu.

At the server side, the system includes the server 106 that includes a web server 306 for managing various service applications. The services provided by the service applications are described in the service profiles stored in the profile database 108. These services can be invoked as set forth in the service profile.

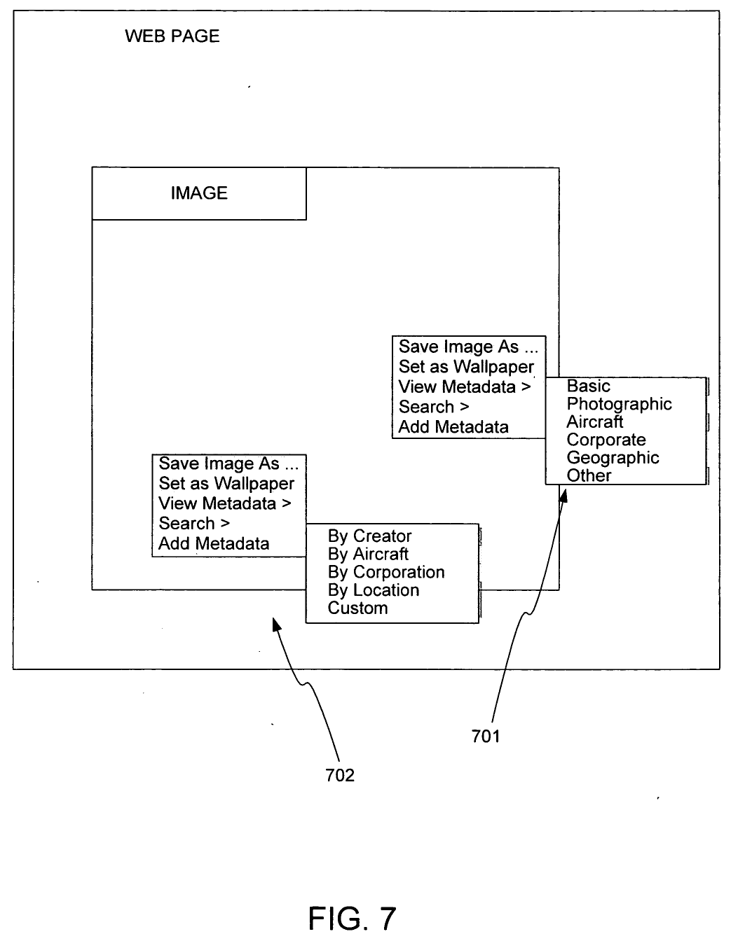

Optionally, the browser 102 can include a context monitor 302 for monitoring contextual information available from the user, the browser 102, the client device 101, or the data streams that the object 103 is associated with, such as an image in a web page. In the preferred embodiment, the context monitor 302 is used in providing the metadata service. A metadata service application 307 provides services for creating, modifying, and/or searching metadata in a database 308 associated with any URL identifiable object. The metadata service application 307 is described further later in this specification with reference to FIGS. 7-9. Any number of other service applications 309, with associated databases 310, is possible. Some example services include usage data collection, copyright enforcement, eCommerce, printing, and searching.

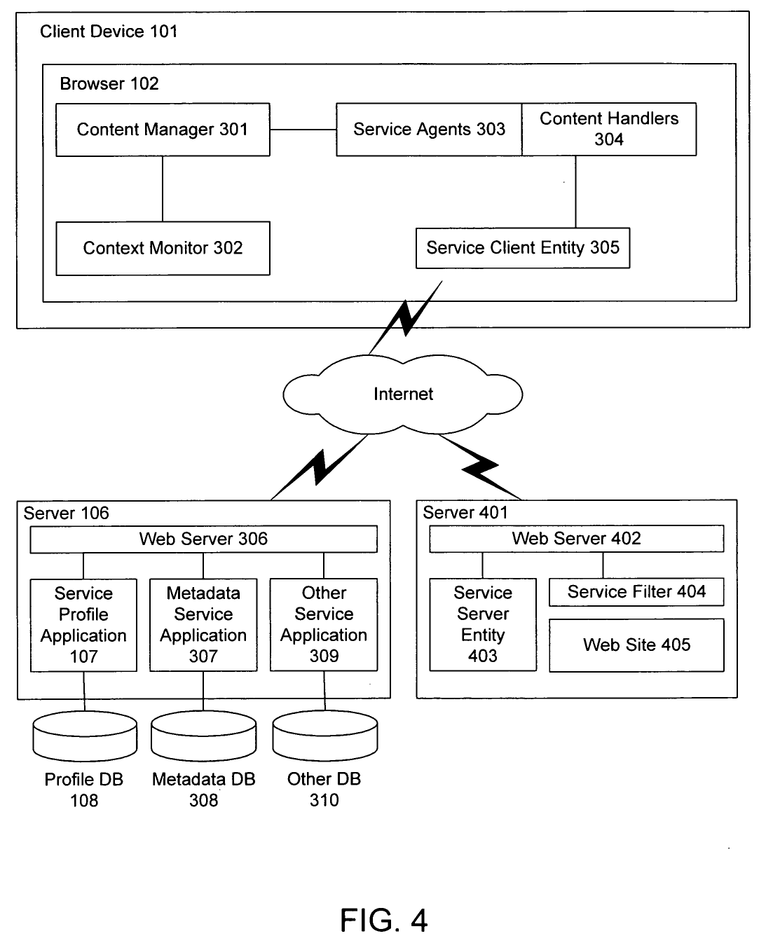

FIG. 4 illustrates a second implementation of the system in accordance with the present invention. In this implementation, the server side further includes a server 401 that includes a web server 402 for managing a service server entity 403 and a service filter 404. Here, the service filter 404, rather than the service agents 303 at the client device 101, processes the object 103 before it is sent from the web site 405 to the browser 102 and ensures that it is associated with a service URL 105. It may provide access to any supported services. The service server entity 403 enables the service profile application 107 and the service filter 404 to communicate.

The service URL may be associated with an object in several ways. For example, the object can carry with it an identifier for where additional services are located. Alternatively, the client device 101 can apply a default service URL associated with various elements of a web page. The client device 101 then asks for this service URL to be inserted into the object. Other mechanisms are possible, such as matching the source URL of an object to another URL, where the other URL is the service URL.

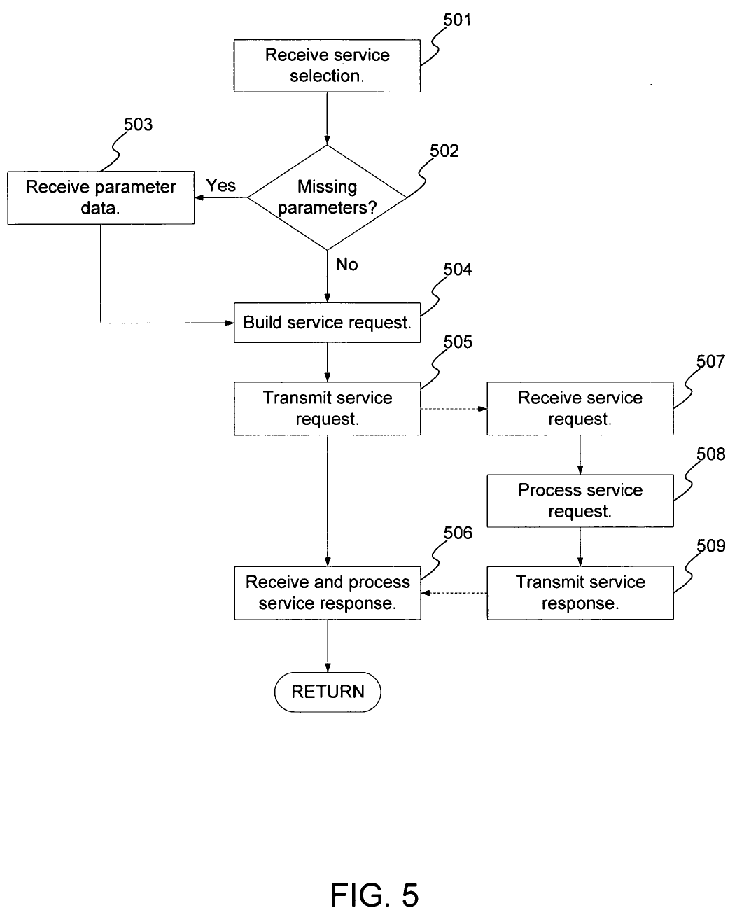

FIG. 5 is a flowchart illustrating a preferred embodiment of a method for processing a service request in accordance with the present invention. Once a service selection is received by the appropriate service agent 303, via step 501, it is determined if any parameters are missing, via step 502. If so, then information that can be gained from the object or its context can be used to fill in the missing parameters. For example, an image's type, file size, and source can be gained from the image itself. If any parameters cannot be obtained in this manner, then the user can be prompted for the missing information. Once the parameter data is received, via step 503, the service agent 303 builds the service request, via step 504, using the service descriptor template from the service profile. The service agent 303 then transmits the request to a specified service application at the server 106, via step 505.

Once the server application receives the service request, via step 507, it processes the service request, via step 508, and transmits the service response back to the client device 101, via step 509. The client device 101 receives and processes the service response, via step 506.

For example, while browsing a web site on airplanes, Ima Pilot, sees an image of an L1011 which she used to fly before she retired. She wants more information about the particular aircraft in the image. Her browser supports a service agent which has access to every image retrieved. The browser found no service URL in the image stream. The service agent contacts the default service and provides the source URL for the image. The service finds an entry for the provided URL and returns an indication to the service agent that service is available for this image.

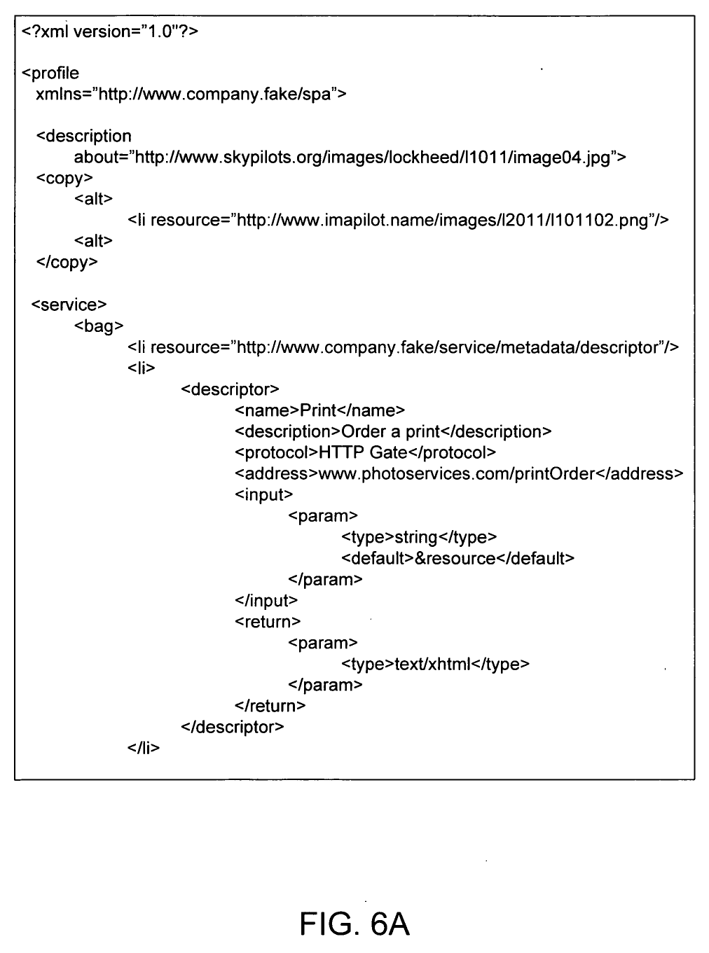

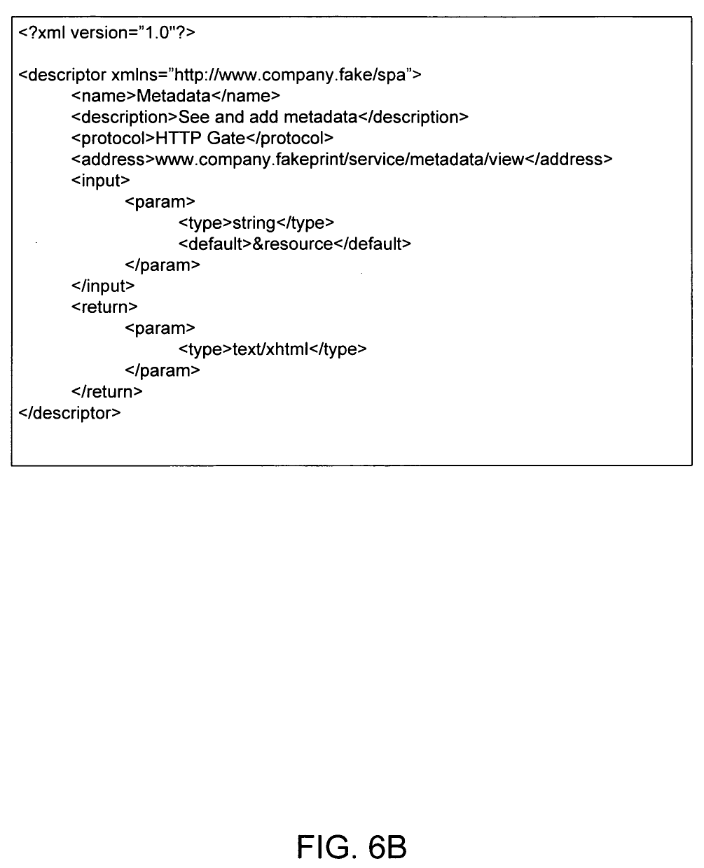

Ms. Pilot right-clicks the image to display the context menu. The service agent retrieves the service profile for the image and uses it to add entries for the available services in the context menu. FIGS. 6A-6B illustrate an example service profile. The profile includes a description of the image, including its source URL, and a description of the service available for the image, such as a print service (FIG. 6A) or a metadata service (FIG. 6B). Included in the service description are any input parameter descriptors associated with the service.

Assume that the context menu items inserted are: “view metadata” with a submenu showing the various vocabularies available (“photographic”, “print”, “image content”, “ownership”, etc.); “Get a copy of the original”; “Get a print”; and “Create new metadata”. Assume that Ms. Pilot opts to view the metadata associated with the image. The browser builds the service request, transmits it to the server, and processes the service responses. In this example, the service agent redirects Ms. Pilot to a web page showing only the identifier for the plane, the location where the image was captured, and the date. Ms. Pilot decides to add information by selecting “Create new metadata”. Ms. Pilot is taken to a web page where she is guided through the available vocabularies she can use. Optionally, Ms. Pilot can create her own vocabulary. She provides all the information she knows about the history of the plane using a vocabulary created for flying machines and the characteristics of the plane.

Later, anyone accessing a copy of this image may retrieve the information Ms. Pilot provided. As copies of the image are registered with the service, the information about the copies are added as metadata. Any metadata in any of the image files retrieved is pulled out and added. For example, assume that Ms. Pilot requests a copy of the original. The service agent sends the request to the service. The service looks up the source URL for the original and makes a request for the original on Ms. Pilot's behalf. If payment is required, Ms. Pilot is redirected to a payment page. The original is retrieved and saved on Ms. Pilot's hard drive. Then, Ms. Pilot can edit the image and send it others. Her photo-editing software creates a new record in the repository for the altered copy with a reference to the original as part of the new image's metadata.

FIG. 7 illustrates the display of an example web page by a browser in making a metadata service available in accordance with the present invention. When a user right-clicks on the image of the Air France plane, a context menu is displayed. The context menu includes a list of available services for the image, as described in the image's service profile. Two example context menus are illustrated. In the context menu 701, the list includes “Save image as . . . ”, “Set as wallpaper”, “View Metadata”, “Search”, and “Add Metadata”. The “View Metadata” service includes a sub-menu listing available metadata vocabularies: “Basic”, “Photographic”, “Aircraft”, “Corporate”, “Geographic”, and “Other. The “Basic” vocabulary could include information such as owner, name of file, when file created, etc. The “Photographic” vocabulary could include information such as image size, number of pixels, lighting, etc. Optionally, the user can select “Other” to create his own vocabulary. The context menu 702 illustrates an example sub-menu for the “Search” service. This sub-menu displays some metadata vocabularies available for searching the metadata for the image. The list includes “By Creator”, “By Aircraft”, “By Corporation”, “By Location”, and “Custom”. Optionally, the web page context can be used to identify more relevant vocabularies.

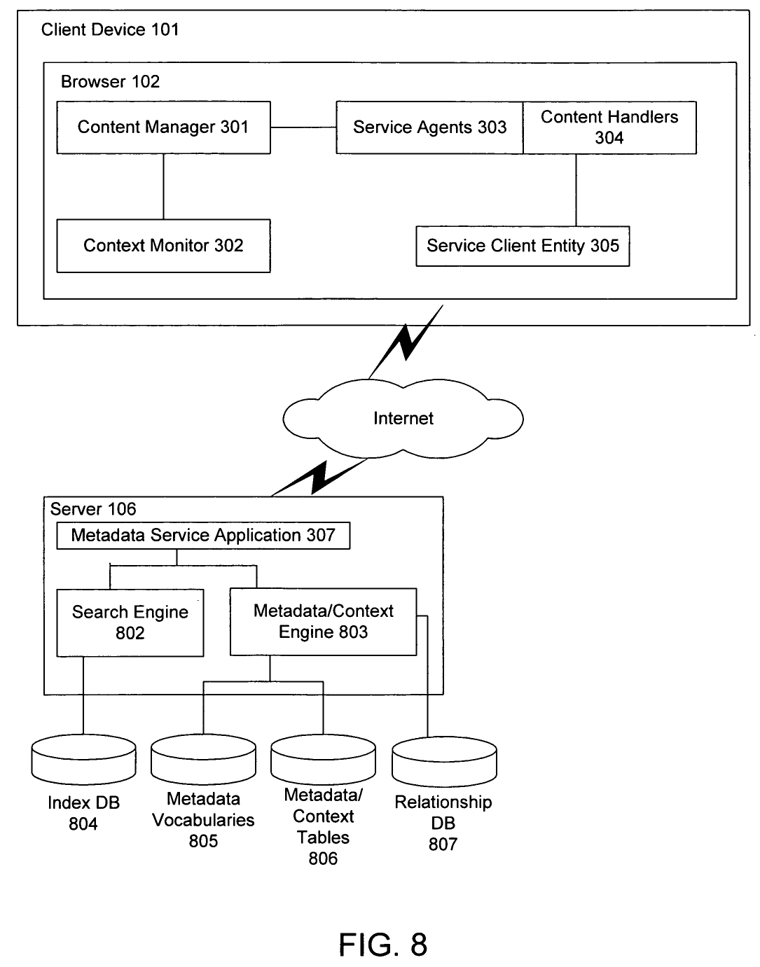

FIG. 8 illustrates a preferred embodiment of a system for providing the metadata service in accordance with the present invention. Here, the metadata service need not be associated with a source of the multimedia object, e.g., a location, such as a website, where the multimedia object is stored or hosted. In this system, the service agent 303 parses an image and examines a web page to see if other information about the image is available. The service agent 303 can request context information from the context monitor 302 and automatically populate the metadata for the image or resource that the service agent 303 is responsible for. The available metadata vocabularies for the image can then be displayed to the user in any number of ways, such as part of the context menu for the image. The user can then select a metadata vocabulary for viewing, modifying, or searching the metadata for the image. If the user provides data using the selected vocabulary, this data is stored as part of the metadata for the image. The metadata vocabularies available or the image is determined based on the object's type or identifier. The metadata vocabulary can be identified using a plurality of metadata services including a second metadata service associated with the source of the object. The metadata services associated and not associated with the source of the object are selectable from any of a plurality of metadata services. Any metadata collected is stored in a repository separate from the object, and the object is linked to the stored metadata using the object's identifier.

The service agents 303 communicate with the server 106 through the service client entity 305. The metadata service application 307 includes a search engine 802 and a metadata/context engine 803. The metadata service application 307 uses vocabulary terms to perform the search of the metadata for the image, and uses the indexes for text that's stored in an index database 804. The metadata/context engine 803 is responsible for managing metadata vocabularies, tables, and their relationships to each other. This information is stored in a metadata vocabulary database 805, metadata/context tables 806, and a relationship database 807.

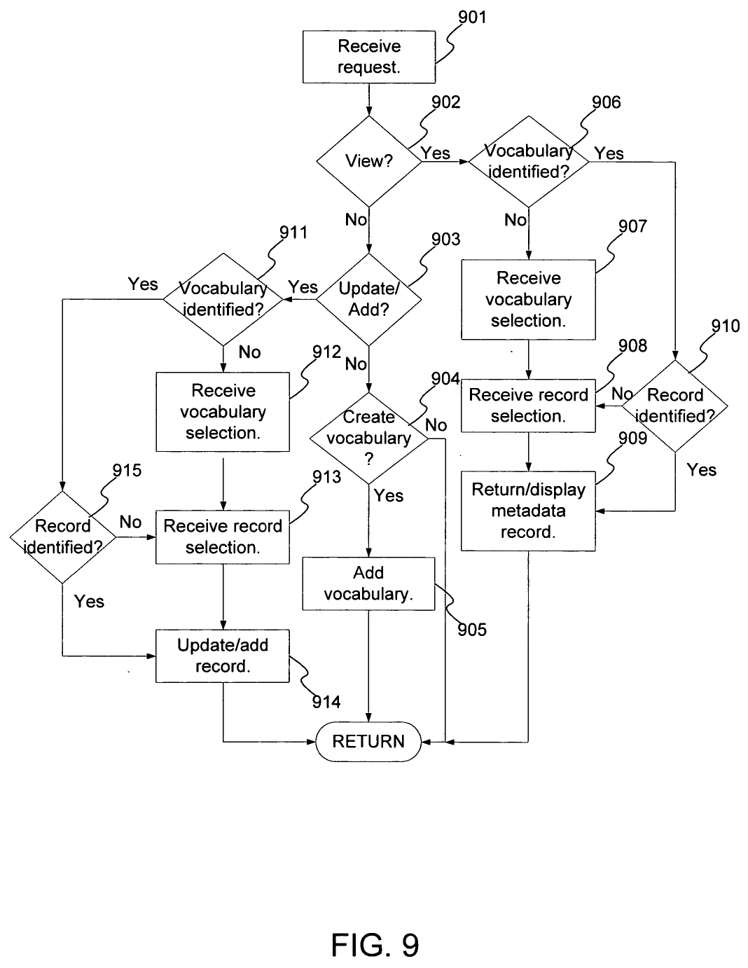

FIG. 9 is a flowchart illustrating a preferred embodiment of a method for providing the metadata service in accordance with the present invention. First, the metadata service application 307 receives a service request, via step 901. If the request is to view metadata information, via step 902, then it is determined if the metadata vocabulary is identified, via step 906. If the vocabulary is identified, then the metadata service application 307 searches for the record in the metadata context tables 806 associated with the resource for the vocabulary, via step 910. If the record is identified, then the metadata in the record is returned and displayed, via step 909. If not, then the appropriate vocabulary is determined and identified based on contextual information. The record associated with the resource for the vocabulary is then selected, via step 908, and the metadata in the record is returned and displayed, via step 909.

If the vocabulary is not identified, via step 906, then a vocabulary is selected. The selection can be based on contextual information or the user can be prompted to select a vocabulary. Once the vocabulary selection is received, via step 907, the record associated with the resource for the vocabulary is selected, via step 908, and the metadata in the record is returned and displayed, via step 909.

If the request is to update or add to existing metadata, via step 903, then it is determined if the vocabulary is identified, via step 911. If it is, then the record associated with the resource for the vocabulary is identified, via step 915, and the metadata is updated and added, via step 914. If the record cannot be identified, then the appropriate vocabulary is determined and identified based on contextual information. The record associated with the resource for the vocabulary is then selected, via step 913, and the metadata in the record is updated or added, via step 914.

If the vocabulary is not identified, via step 911, then a vocabulary is selected, via step 912. The selection can be based on contextual information or the user can be prompted to select a vocabulary. Once the vocabulary selection is received, the record associated with the resource for the vocabulary is selected, via step 913, and the metadata in the record is updated or added, via step 914.

If the request is to create a vocabulary, via step 904, then the vocabulary is added to the metadata vocabulary database 805, via step 905. The vocabulary can be created from an existing vocabulary. The creating of a vocabulary is described in co-pending U.S. patent application entitled, “Specifying, Assigning, and Maintaining User Defined Metadata in a Network-Based Photosharing System”, Ser. No. 10/034,277, filed on Dec. 28, 2001, and assigned to the assignee of the present application. This patent application is hereby incorporated by reference.

The illustrated process can be optimized to prevent unneeded updates of the metadata. For example, a timestamp of the last update and a record of changes since the last update can be maintained. Image processing can also be performed on a service to identify duplicates and altered copies. Optionally, usage tracking and copyright infringement detection can be provided as part of a service, where possible duplicate copies are identified through image analysis and metadata analysis. Further, other options can be provided. For example, multiple service URL's and/or multiple services can be provided to allow interoperability to create a distributed repository; user's can be allowed to register new services for an image or a set of images that meet specified matching criteria where the criteria can include metadata and/or image data; a server could provide the service URL as part of the web page markup; and the process can be extended to any addressable item on the web (movies, audios, documents of various types, web pages and portions of web pages, photo albums, user groups, etc.).

For example, Joe Audio and friends create a web site with articles on jazz music. The site also has reviews, history, forums, etc. Some of the information is in a database, so the page content is generated on the fly. No metadata is provided for the songs, images, movies, and text objects served by their site.

Annabel discovers Joe's site through a search engine. She views a page which provides a link to an audio stream of a song, the lyrics of which were written by her grandfather. Annabel right clicks on the page to bring up the context menu, which includes “Provide more info”. She selects the “Provide more info” service, and the browser shows the title of the page and URL of the page she wants to provide more information about. It provides various links, such as links to see information already available for the page, links for words on the page (such as “song” or “artist”), and links for providing information (such as “song writer” or “song history”). There is an indicator next to the “song writer” link to indicate that data has already been provided for that link. She selects it and sees entries for her grandfather's last name, his nationality, but the other entries are blank. Annabel provides her grandfather's full name and stage name, among other information which are then added to the metadata for the song. She wants to share more information so she selects the “add more data” service from the context menu. She is then taken to a search page to search for a vocabulary that fits what she wants to enter. She enters “family” and is presented with vocabularies related to family history, personal history, family tree, etc. She selects the family history vocabulary. She is taken through a series of forms where she describes her grandfather's personal history. She comes back another day to fill-in data related to other vocabularies. At that time, she can also return to Joe's web site and right clicks on the audio file link for the song to see what information has been collected for the song. The collected information would include Annabel's information about her grandfather provided along side information provided by others. Annabel can be given the option to provide feedback about Joe's website. This feedback would then be stored as metadata and can be provided to Joe for a fee.

Visitors to the site can certify themselves. Others can score them for relevance and accuracy. Although illustrated with a browser, web services can be provided so that non-browser applications can use the service without departing from the spirit and scope of the present invention. For example, a desktop imaging application, such as PHOTOSHOP from Adobe System, Inc., could use the service URL in an image to make services associated with the image available through PHOTOSHOP's user interface. PHOTOSHOP may add its own service URL to each image it processes, so that services associated with PHOTOSHOP are available for each image when they are loaded by a browser or other application that is compatible with the service URL system.

A method and system for automatically creating a metadata repository for multimedia objects have been disclosed. The method and system includes a service URL in the metadata associated with a multimedia object. The service URL is used by a browser to access a service profile application to retrieve a service profile. The service profile describes the services available to the multimedia object and how to invoke these services. One of the services that can be provided is a metadata service that allows users to view, modify, or search the metadata for the multimedia object. In this manner, a common mechanism for providing information related to the multimedia object and for providing or advertising services related to the object is provided.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing metadata for multimedia objects, comprising:
determining if metadata associated with a multimedia object comprises a service uniform resource locator (URL);
receiving a service profile for the multimedia object utilizing the service URL, if the metadata comprises the service URL; and
making at least one service described in the service profile available.

2. The method of claim 1, wherein the determining comprises:
registering the multimedia object with a service profile application, if the metadata does not comprise the service URL.

3. The method of claim 2, wherein the registering comprises:
determining the service URL to be associated with the multimedia object based upon context data; and
including the service URL in the metadata.

4. The method of claim 1, wherein the determining comprises:
determining if the metadata comprises the service URL by a service agent included in an application; and
requesting the service profile from a service profile application utilizing the service URL, if the metadata comprises the service URL.

5. The method of claim 1, wherein the determining comprises:
determining if the metadata comprises the service URL by a server filter at a server; and
sending the multimedia object with the metadata to an application, if the metadata comprises the service URL.

6. The method of claim 1, wherein the making comprises:
displaying the service in a context menu of the multimedia object.

7. The method of claim 1, further comprising:
receiving a selection of the at least one service;
building a service request for the service; and
transmitting the service request to a service application according to the service profile.

8. The method of claim 7, wherein the building comprises:
determining a value for at least one parameter for the service request, wherein the parameter is defined in the service profile.

9. The method of claim 8, wherein the determining comprises:
determining a value for the parameter for the service request from contextual data.

10. The method of claim 8, wherein the determining comprises:
prompting a user for the value of the parameter for the service request.

11. The method of claim 7, further comprising:
receiving the service request by the service application;
processing the service request by the service application; and
returning a service response by the service application.

12. A system, comprising:
a client device capable of supporting an application, wherein the application is capable of displaying a multimedia object comprising metadata, wherein the metadata comprises a service uniform resource location (URL); and
a server comprising a service profile application, wherein the service profile application manages a service profile for the multimedia object, wherein the service profile describes at least one service for the multimedia object, and wherein the client device can obtain the service profile utilizing the service URL and make the service available.

13. The system of claim 12, wherein the application comprises:
a content manager for processing the metadata of the multimedia object;
at least one service agent for receiving the metadata from the content manager and for determining if the metadata comprises the service URL; and
a service client entity, wherein the service agent communicates with the server utilizing the service client entity to obtain the service profile.

14. The system of claim 12, wherein the server comprises:
the service profile application; and
at least one service application for providing the service.

15. The system of claim 14, wherein the server further comprises:
a service filter for processing the multimedia object prior to sending it to the application and for determining if the metadata of the multimedia object comprises the service URL; and
a service server entity, wherein the service filter communicates with the service profile application utilizing the service server entity to register the multimedia object with the service profile application, if the multimedia object does not comprise the service URL.

16. A computer readable medium with program instructions for providing metadata for multimedia objects, comprising:
determining if metadata associated with a multimedia object comprises a service uniform resource locator (URL);
receiving a service profile for the multimedia object utilizing the service URL, if the metadata comprises the service URL; and
making at least one service described in the service profile available.

17. The medium of claim 16, wherein the determining comprises:
registering the multimedia object with a service profile application, if the metadata does not comprise the service URL.

18. The medium of claim 16, wherein the determining comprises:
determining if the metadata comprises the service URL by a service agent included in an application; and
requesting the service profile from a service profile application utilizing the service URL, if the metadata comprises the service URL.

19. The medium of claim 16, wherein the determining comprises:
determining if the metadata comprises the service URL by a server filter at a server; and
sending the multimedia object with the metadata to an application, if the metadata comprises the service URL.

20. The medium of claim 16, wherein the making comprises:
displaying the service in a context menu of the multimedia object.
